(19) United States
(12) Patent Application Publication
(10) Pub. No.: US 2015/0035697 A1
(43) Pub. Date: Feb. 5, 2015

(54) RADAR CALIBRATION SYSTEM FOR VEHICLES

(71) Applicant: MANDO CORPORATION, Pyeongtaek-si (KR)

(72) Inventor: Ji-Hoon CHO, Gunpo-si (KR)

(21) Appl. No.: 14/306,015

(22) Filed: Jun. 16, 2014

(30) Foreign Application Priority Data
Jul. 31, 2013 (KR) 10-2013-0090554

(51) Int. Cl. G01S 7/40

(52) U.S. Cl. CPC G01S 7/4052; G01S 2007/4065
USPC 342/172

(57) ABSTRACT

Disclosed herein is a radar calibration system for vehicles. The radar calibration system for vehicles includes a target simulator receiving a radar signal through a reception antenna, delaying the received signal through a delay line, and transmitting the delayed signal through a transmission antenna, and a radar apparatus transmitting the radar signal to the target simulator through a transmission antenna, receiving the delayed signal from the target simulator through a plurality of reception antennas, calculating phase differences among the delayed signals received through the plurality of reception antennas, and generating and storing phase correction values of reception channels of the plurality of reception antennas to correct the calculated phase differences.

### CROSS-REFERENCE TO RELATED APPLICATION

This application claims the benefit of Korean Patent Application No. 2013-0090554, filed on Jul. 31, 2013 in the Korean Intellectual Property Office, the disclosure of which is incorporated herein by reference.

### BACKGROUND

1. Field

Embodiments of the present invention relate to a radar calibration system for vehicles in which a reception antenna array including a plurality of reception antennas is provided.

2. Description of the Related Art

In general, a radar apparatus is an apparatus which senses a distance from an object and direction and altitude of the object by transmitting a signal toward the object and receiving a signal reflected by the object.

Such a radar apparatus is applied to various fields requiring object sensing. Particularly, in an automobile industry, a radar apparatus is mounted in a vehicle and is operated by interworking with various vehicle control systems using an object sensed result in vehicle control.

In order to acquire high angular resolution, a radar apparatus having an antenna array including a plurality of reception antennas may calculate phase differences among the reception antennas and thus extract a target angle. However, in such a radar apparatus, physical characteristics of antenna elements are changed due to an error in a manufacturing process. In order to achieve the same performance of all modules, such a physical error needs to be minimized.

In a conventional radar calibration method for vehicles, a radar mounting error is calculated and corrected using phase information of a signal reflected by a target of a short distance in a restricted space or an anechoic chamber.

However, since the signal reflected by the short-distance target is sensitive to noise of a surrounding environment and a noise of a system itself, respective reception channels may be difficult to precisely extract phase values of the signal reflected by the short-distance target and thus, radar calibration in which phase correction values for correction of the phase values is calculated and stored may not be precisely carried out.

### SUMMARY

Therefore, it is an aspect of the present invention to provide a radar calibration system for vehicles which performs calibration of a radar apparatus for vehicles using a target simulator located at a short distance but serving as a long-distance target due to signal delay so as to enhance of radar calibration performance.

Additional aspects of the invention will be set forth in part in the description which follows and, in part, will be obvious from the description, or may be learned by practice of the invention.

In accordance with one aspect of the present invention, a radar calibration system for vehicles includes a target simulator receiving a radar signal through a reception antenna, delaying the received signal through a delay line, and transmitting the delayed signal through a transmission antenna and a radar apparatus transmitting the radar signal to the target simulator through a transmission antenna, receiving the delayed signal from the target simulator through a plurality of reception antennas, calculating phase differences among the delayed signals received through the plurality of reception antennas, and generating and storing phase correction values of reception channels of the plurality of reception antennas to correct the calculated phase differences.

The target simulator may include the transmission antenna, the reception antenna, a delay line unit causing the received signal to pass through a delay passage having a predetermined length to delay the signal received through the reception antenna, and a transmission controller transmitting the signal having passed through the delay line unit to the radar apparatus through the transmission antenna.

The delay line unit may include an optical cable.

The radar apparatus may transmit the radar signal to the target simulator through the transmission antenna, receive the delayed signal from the target simulator through a reception antenna array including the plurality of reception antennas, detects phases of the signals received by the reception channels of the plurality of reception antennas, calculate phase correction values causing the phases of other reception channels to be identical with the phase of one reception channel selected from the reception channels, and store the calculated phase correction values in a memory of the radar apparatus.

In accordance with another aspect of the present invention, a radar calibration system for vehicles includes a target simulator including a transmission antenna, a reception antenna, a delay line unit causing a signal received through the reception antenna to pass through a delay passage having a predetermined length to delay the received signal, and a transmission controller transmitting the signal having passed through the delay line unit to the radar apparatus through the transmission antenna, and a radar apparatus including a transmission antenna and a reception antenna array including a plurality of reception antennas, transmitting a radar signal to the target simulator through the transmission antenna, receiving a signal transmitted from the target simulator through the plurality of reception antennas, detecting phases of the signals received by reception channels of the plurality of reception antennas, calculating phase correction values causing the phases of other reception channels to be identical with the phase of one reception channel selected from the reception channels, and storing the calculated phase correction values in a memory of the radar apparatus.

The delay line unit may include an optical cable.

The target simulator and the radar apparatus may be arranged so that the signal transmitted by the transmission antenna of the target simulator is transmitted to the radar apparatus in the direction of 0 degrees regardless of the zero point of the signal transmitted by the radar apparatus.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a control block diagram of a radar calibration system for vehicles in accordance with one embodiment of the present invention;

FIG. 2 is a block diagram illustrating the configuration of a target simulator in the radar calibration system for vehicles in accordance with the embodiment of the present invention;

FIG. 3 is a graph illustrating relations between a signal reflected by a short-distance target and noise of a surrounding environment, if the short-distance target is used instead of the target simulator, in the radar calibration system for vehicles in accordance with the embodiment of the present invention;

FIG. 4 is a graph illustrating relations between a signal transmitted by a target simulator and noise of a surrounding environment the target simulator in the radar calibration system for vehicles in accordance with the embodiment of the present invention; and

FIG. 5 is a view illustrating the configuration of a radar apparatus in the radar calibration system for vehicles in accordance with the embodiment of the present invention.

### DETAILED DESCRIPTION

Reference will now be made in detail to the embodiments of the present invention, examples of which are illustrated in the accompanying drawings, wherein like reference numerals refer to like elements throughout. In the following description of the present invention, a detailed description of known functions and configurations incorporated herein will be omitted when it may make the subject matter of the present invention rather unclear. In the drawings, the widths, the lengths, the thicknesses, etc. of elements may be exaggerated for convenience of description. Further, in the drawings, the same or similar elements are denoted by the same reference numerals even though they are depicted in different drawings.

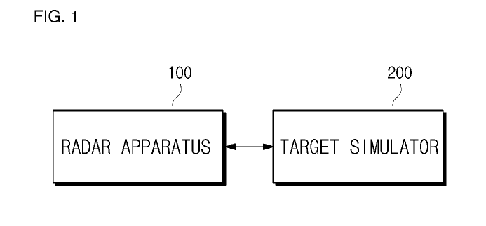

FIG. 1 is a control block diagram of a radar calibration system for vehicles in accordance with one embodiment of the present invention.

With reference to FIG. 1, a radar calibration system for vehicles includes a radar apparatus 100 and a target simulator 200.

The radar apparatus 100 is an apparatus which senses a distance from an object and direction and altitude of the object by transmitting a signal toward the object and receiving a signal reflected by the object. The radar apparatus 100 is operated by interworking with various vehicle control systems using an object sensed results in vehicle control.

The radar apparatus 100 transmits a radar signal to the target simulator 200 and receives a signal transmitted from the target simulator 200.

The target simulator 200 is located at a relatively short distance from the radar apparatus 100 but serves as a long-distance target. The target simulator 200 delays the radar signal transmitted from the radar apparatus 100 and transmits the delayed signal to the radar apparatus 100 again.

The radar apparatus 100 transmits a radar signal to the target simulator 200, receives the delayed signal from the target simulator 200 through a plurality of channels, calculates phase differences among the respective channels, and generates and stores phase correction values of the respective channels to correct the calculated phase differences.

That is, the radar apparatus 100 may receive a signal, which is delayed by the target simulator 200 and is thus easily distinguishable from surrounding environmental noise, through the respective reception antennas and generate and store phase correction values of respective channels of the reception antennas to correct phase differences among the respective channels, thus correcting subsequent horizontal angles. That is, by delaying a signal transmitted from the radar apparatus 100 to the target simulator 200 by passing through a delay line of the target simulator 200 and then by transmitting the delayed signal to the radar apparatus 100, the radar apparatus 100 may have the same effect as the effect of transmitting a signal to a long-distance target and then receiving a signal reflected by the long-distance target.

Therefore, the radar apparatus 100 may receive a signal reliably distinguishable from surrounding environment noise, as compared to a short-distance target, and thus, avoid influence of noise of a surrounding environment having the same distance as the short-distance target located within a restricted space and multiple reflection occurred due to a high reception signal and calculate more precise phase values of the reception signal.

These corrected values are stored in a memory of the radar apparatus 100 or a vehicle and, when an object is detected during driving of the vehicle and a signal reflected by the object is received and analyzed, the stored values are used in sensing of a distance from the object and direction and altitude of the object.

That is, the radar apparatus 100 needs to adjust phases of the respective reception antennas so that the directions of the same target detected by reception channels of the respective reception antennas are identical. In general, such radar calibration is carried out by providing phase correction values of the reception channels of the respective reception antennas in a signal processing stage.

Since the phase correction values of the reception channels are inherent in a manufactured radar apparatus, the values are determined through separate measurement. For example, the radar apparatus 100 is operated under the condition that the target simulator 200 is disposed on the front surface of the radar apparatus 100, and phase correction values of the reception channels of the respective reception antennas when the directions of the target detected by the reception channels are the direction of 0 degrees are calculated. These phase correction values of the channels are stored in the memory of the radar apparatus 100 and, if the radar apparatus 100 is mounted in a vehicle and processes a radar signal, the phases of the reception channels are coincided with each other by applying the respective phase correction values to the respective reception channels. In addition, the phase value of one reception channel may be set as a reference phase value and phase correction values of other reception channels to coincide the phase values of these reception channels with the reference phase value may be calculated and stored.

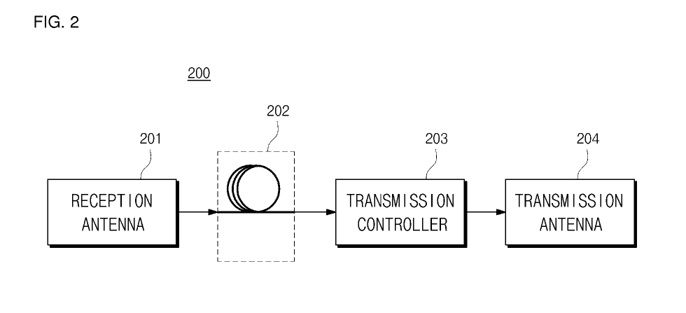

FIG. 2 is a block diagram illustrating the configuration of the target simulator 200 in the radar calibration system for vehicles in accordance with the embodiment of the present invention.

With reference to FIG. 2, the target simulator 200 includes a reception antenna 201, a delay line unit 202, a transmission controller 203, and a transmission antenna 204.

The target simulator 200 is located at a relatively short distance from the radar apparatus 100 but serves as a long-distance target. For this purpose, the target simulator 200 receives a radar signal from the radar apparatus 100 through the reception antenna 201 and delays the received signal through the delay line unit 202 (for example, an optical cable). Further, the transmission controller 203 of the target simulator 200 transmits the delayed signal to the radar apparatus 100 again through the transmission antenna 203.

Since the target simulator 200 and the radar apparatus 100 are arranged so that the signal transmitted by the transmission antenna 204 of the target simulator 200 may be transmitted to the radar apparatus 100 in the direction of 0 degrees at all times regardless of the zero point of the signal transmitted by the radar apparatus 100, precision in setting of the zero point is increased and thus, precision of phase values extracted by the reception channels of the respective reception antennas of the radar apparatus 100 is improved.

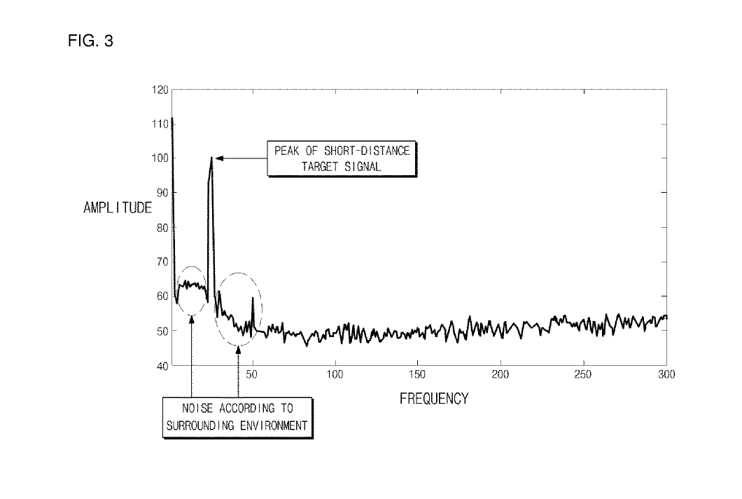

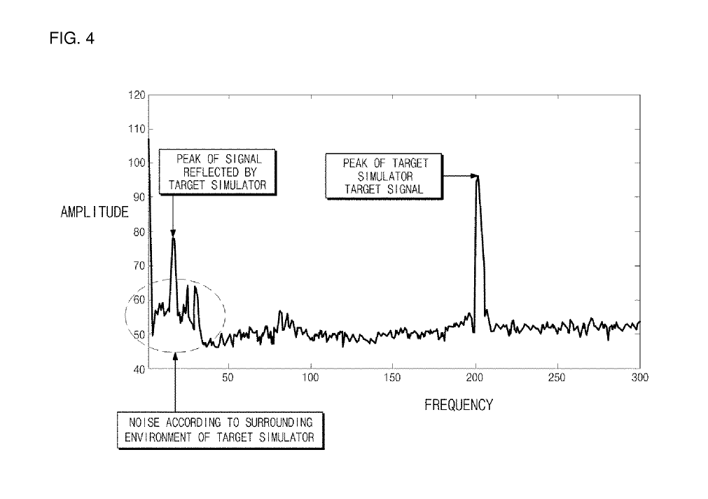

FIG. 3 is a graph illustrating relations between a signal reflected by a short-distance target and noise of a surrounding environment, if the short-distance target is used instead of the target simulator, in the radar calibration system for vehicles in accordance with the embodiment of the present invention, and FIG. 4 is a graph illustrating relations between a signal transmitted by the target simulator and noise of a surrounding environment of the target simulator in the radar calibration system for vehicles in accordance with the embodiment of the present invention.

With reference to FIG. 3, if the radar apparatus 200 receives a signal reflected by a short-distance target in the same manner as the conventional radar apparatus, the short-distance target signal is influenced by noise of a surrounding environment and thus, it may be difficult to extract the short-distance target signal alone. Therefore, such noise may influence phase value extraction of the target signal and incorrect phase values may be extracted.

On the other hand, with reference to FIG. 4, if the radar apparatus 100 receives a signal transmitted by the target simulator 200, such a signal is a target simulator target signal, i.e., a long-distance target signal having a longer frequency than the short-distance target signal, and is thus not influenced by surrounding environmental noise of the target simulator 200 around a frequency in the range of 0 to 50. Further, there is no noise around the peck of the target simulator target signal and thus, the target signal alone may be easily extracted. Therefore, phase value extraction of the target signal may be more reliably and precisely performed.

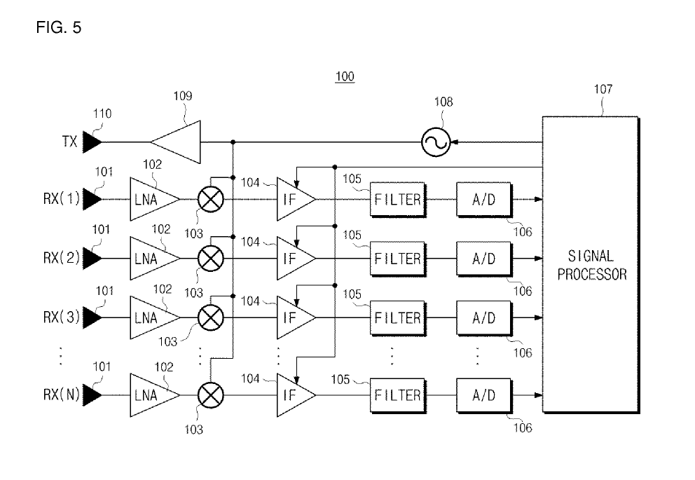

FIG. 5 is a view illustrating the configuration of the radar apparatus in the radar calibration system for vehicles in accordance with the embodiment of the present invention.

With reference to FIG. 5. the radar apparatus 100 may include a reception antenna array 101 including reception antennas RX(1)˜RX(N), low noise amplifiers (LNA) 102, mixers 103, IF amplifiers 104, filters 105, A/D converters 106, a signal processor 107, an oscillator 108, an amplifier 109, and a transmission antenna 110.

A signal output by the oscillator 108 is amplified by the amplifier 109 and transmitted to the target simulator 200 through the transmission antenna 110. Here, output (for example, amplitude, frequency, transmission timing, etc.) of the oscillator 108 is controlled by the signal processor 107.

The respective reception antennas RX(1)˜RX(N) of the reception antenna array 101 receive the signal transmitted from the target simulator 200, and the signals received by the reception antennas RX(1)˜RX(N) are amplified by the low noise amplifiers (LNA) 102 provided in reception channels of the respective reception antennas RX(1)˜RX(N) and input to the mixers 103. The mixers 103 mix the received signals with the transmitted signal and thus down-converts the received signals into base band signals. Then, the base band signals are input to the A/D converters 106 via the IF amplifiers 104 and the filters 105. The signals input to the A/D converters 106 are converted into digital signals and then, the digital signals are transmitted to the signal processor 107.

The signal processor 107 perform radar calibration by detecting phases of the respective reception antennas from the signals received by the respective reception antennas RX(1)˜RX(N), calculating phase correction values of the respective reception channels such that the phase of one reception channel selected from the respective reception channels, for example, the reception channel of the reception antenna located at the center, is set as a reference phase and the phases of other reception channels are identical with the reference phase, and storing the calculated phase correction values in a memory of the radar apparatus 100.

Although the above embodiment describes that transmission antenna and the reception antenna(s) are separated for convenience for description, one transmission/reception antenna may be used.

As is apparent from the above description, a radar calibration system for vehicles in accordance with one embodiment of the present invention more precisely and reliably extracts phase values of respective reception channels using a target simulator, which is located at a relatively short distance from a radar apparatus but serves as a long-distance target, and generates and stores phase correction values to correct the extracted phase values, thus avoiding influence of noise of a surrounding environment having the same distance as a short-distance target located within a restricted space and multiple reflection occurred due to a high reception signal and extracting more precise phase values of the respective reception channels from the signal acquired from the long-distance target.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A radar calibration system for vehicles comprising:
a target simulator receiving a radar signal through a reception antenna, delaying the received signal through a delay line, and transmitting the delayed signal through a transmission antenna; and
a radar apparatus transmitting the radar signal to the target simulator through a transmission antenna, receiving the delayed signal from the target simulator through a plurality of reception antennas, calculating phase differences among the delayed signals received through the plurality of reception antennas, and generating and storing phase correction values of reception channels of the plurality of reception antennas to correct the calculated phase differences.

2. The radar calibration system for vehicles according to claim 1, wherein the target simulator includes the transmission antenna, the reception antenna, a delay line unit causing the received signal to pass through a delay passage having a predetermined length to delay the signal received through the reception antenna, and a transmission controller transmitting the signal having passed through the delay line unit to the radar apparatus through the transmission antenna.

3. The radar calibration system for vehicles according to claim 2, wherein the delay line unit includes an optical cable.

4. The radar calibration system for vehicles according to claim 1, wherein the radar apparatus transmits the radar signal to the target simulator through the transmission antenna, receives the delayed signal from the target simulator through a reception antenna array including the plurality of reception antennas, detects phases of the signals received by the reception channels of the plurality of reception antennas, calculates phase correction values causing the phases of other reception channels to be identical with the phase of one reception channel selected from the reception channels, and stores the calculated phase correction values in a memory of the radar apparatus.

5. A radar calibration system for vehicles comprising:
a target simulator including a transmission antenna, a reception antenna, a delay line unit causing a signal received through the reception antenna to pass through a delay passage having a predetermined length to delay the received signal, and a transmission controller transmitting the signal having passed through the delay line unit to the radar apparatus through the transmission antenna; and
a radar apparatus including a transmission antenna and a reception antenna array including a plurality of reception antennas, transmitting a radar signal to the target simulator through the transmission antenna, receiving a signal transmitted from the target simulator through the plurality of reception antennas, detecting phases of the signals received by reception channels of the plurality of reception antennas, calculating phase correction values causing the phases of other reception channels to be identical with the phase of one reception channel selected from the reception channels, and storing the calculated phase correction values in a memory of the radar apparatus.

6. The radar calibration system for vehicles according to claim 5, wherein the delay line unit includes an optical cable.

7. The radar calibration system for vehicles according to claim 5, wherein the target simulator and the radar apparatus are arranged so that the signal transmitted by the transmission antenna of the target simulator is transmitted to the radar apparatus in the direction of 0 degrees regardless of the zero point of the signal transmitted by the radar apparatus.
